(19) United States
(12) Patent Application Publication
(10) Pub. No.: US 2018/0098394 A1
(43) Pub. Date: Apr. 5, 2018

(54) OPTOELECTRONIC CIRCUIT COMPRISING LIGHT-EMITTING DIODES

(71) Applicant: EASII IC, Grenoble (FR)

(72) Inventors: David GRAS, Echirolles (FR); Thomas PEYSSON, La Buisse (FR)

(21) Appl. No.: 15/719,612

(22) Filed: Sep. 29, 2017

(30) Foreign Application Priority Data
Sep. 30, 2016 (FR) 1659452

(51) Int. Cl. H05B 33/08

(52) U.S. Cl. CPC H05B 33/083

(57) ABSTRACT

An optoelectronic circuit intended to receive a variable voltage containing an alternation of rising and falling phases. The optoelectronic circuit includes assemblies of series-assembled light-emitting diodes, a node coupled to each assembly by a conduction circuit having its electric conductance varying according to a control signal and a control circuit coupled to each conduction circuit and capable of supplying each control signal based on the comparison of a first voltage at said node with at least a second voltage. The control circuit includes a difference amplifier and as many output stages as there are conduction circuits, the control circuit being capable of controlling the first voltage with the second voltage offset by a third voltage, different for each output stage.

### FIELD

The present description relates to an optoelectronic circuit, particularly to an optoelectronic circuit comprising light-emitting diodes.

### BACKGROUND

It is desirable to be able to power an optoelectronic circuit comprising light-emitting diodes with an AC voltage, particularly a sinusoidal voltage, for example, the mains voltage.

FIG. 1 shows an example of an optoelectronic circuit 10 comprising input terminals IN₁ and IN₂ having an AC voltage V_{IN} applied between them. Optoelectronic circuit 10 further comprises a rectifying circuit 12 comprising a diode bridge 14, receiving voltage V_{IN} and supplying a rectified voltage V_{ALIM} which powers light-emitting diodes 16, for example, series-assembled with a resistor 15. The current flowing through light-emitting diodes 16 is called I_{ALIM}.

FIG. 2 is a timing diagram of power supply voltage V_{ALIM} and of power supply current I_{ALIM} for an example where AC voltage V_{IN} corresponds to a sinusoidal voltage. When voltage V_{ALIM} is greater than the sum of the threshold voltages of light-emitting diodes 16, light-emitting diodes 16 become conductive. Power supply current I_{ALIM} then follows power supply voltage V_{ALIM}. There is therefore an alternation of phases OFF without light emission and of light-emission phases ON.

A disadvantage is that as long as voltage V_{ALIM} is smaller than the sum of the threshold voltages of light-emitting diodes 16, no light is emitted by optoelectronic circuit 10. An observer may perceive this lack of light emission when the duration of each phase OFF with no light emission between two light-emission phases ON is too long. A possibility, to increase the duration of each phase ON, is to decrease the number of light-emitting diodes 16. A disadvantage then is that the proportion of electric power lost in the resistor is significant.

Publication US 2014/0252968 describes an optoelectronic circuit where the number of light-emitting diodes receiving power supply voltage V_{ALIM} progressively increases during a rising phase of the power supply voltage and progressively decreases during a felling phase of the power supply voltage This is achieved by a switching device capable of short-circuiting a variable number of groups of light-emitting diodes according to the variation of voltage V_{ALIM}. This enables to decrease the duration of each phase with no light emission.

A disadvantage of the optoelectronic circuit described in publication US 2014/0252968 is that it requires using a difference amplifier for each group of light-emitting diodes. The circuit may thus have a high manufacturing cost. Another disadvantage is that the electric power consumption of the optoelectronic circuit may be significant. Another disadvantage is the complexity of the optoelectronic circuit, which may cause reliability issues.

Publication US-A-2013/0200802 describes an optoelectronic circuit comprising a plurality of series-assembled diodes and a switching device capable of short-circuiting a greater or lesser number of light emitting diodes according to the variation of the power supply voltage. The switching circuit comprises a differential amplifier.

### SUMMARY

An object of an embodiment is to overcome all or part of the disadvantages of the previously-described optoelectronic circuits.

Another object of an embodiment is to decrease the duration of phases -with BO light emission of the optoelectronic circuit.

Another object of aft embodiment is for the current powering the light-emitting diodes to vary substantially continuously.

Another object of an embodiment is to have a decreased number of components of the optoelectronic circuit switching device.

Thus, an embodiment provides an optoelectronic circuit intended to receive a variable voltage containing an alternation of rising and falling phases, the optoelectronic circuit comprising:
assemblies of series-assembled light-emitting diodes;
a node coupled to each assembly by a conduction circuit having an electric conductance which varies according to a control signal; and
a control circuit coupled to each conduction circuit comprising a difference amplifier and as many output stages as there are conduction circuits, and capable of supplying each control signal based on the comparison of a first voltage at said node with at least a second voltage identical for all conduction circuits, the control circuit being capable of controlling the first voltage with the second voltage offset by a third voltage, different for each output stage.

According to an embodiment, the difference amplifier receives as an input a differential voltage corresponding to the difference between the first voltage and the second voltage.

According to an embodiment, the difference amplifier is capable of supplying a first current and a second current, the control circuit comprising a first current mirror with a plurality of outputs capable of copying, for each conduction circuit, the first current or a third current multiplied by a first copying factor, and a second current mirror with a plurality of outputs capable of copying, for each conduction circuit, the second current or the third current multiplied by a second copying factor, the ratio of the first copying factor to the second copying factor being different for each conduction circuit.

According to an embodiment, the assemblies of light-emitting diodes are ordered by increasing rank from a first assembly at a first end of the series to a last assembly at a second end of the series and, for each conduction circuit, the control circuit is capable of controlling the first voltage with the second voltage decreased by a third voltage which decreases with the rank of the assembly having the conduction circuit coupled thereto.

According to an embodiment, the difference amplifier comprises a differential pair comprising a first transistor receiving the first voltage and a second transistor receiving the second voltage.

According to an embodiment, the first transistor is a MOS transistor having its gate receiving the first voltage and the second transistor is a MOS transistor having its gate receiving the second voltage.

According to an embodiment, the optoelectronic circuit comprises, for each conduction circuit, a capacitor coupled to the conduction circuit or integrated to the conduction circuit, the first current mirror comprising a capacitor charge circuit and the second current mirror comprising a capacitor discharge circuit.

According to an embodiment, each conduction circuit comprises a MOS transistor.

According to an embodiment, the first current mirror comprises, for each conduction circuit, a first copying block coupled to the gate of the MOS transistor of the conduction circuit and capable of supplying the first current multiplied by the first copying factor and the second current mirror comprises, for each conduction circuit, a second copying block coupled to the gate of the MOS transistor of the conduction circuit and capable of supplying the second current multiplied by the second copying factor.

According to an embodiment, the optoelectronic circuit comprises a current source coupled to said node.

According to an embodiment, the current source comprises at least one resistor.

According to an embodiment, the current source is capable of supplying a current which increases with the rank of the assembly having the conduction circuit coupled thereto.

According to an embodiment, the third voltage varies according to temperature.

The foregoing and other features and advantages will be discussed in detail in the following non-limiting description of specific embodiments in connection with the accompanying drawings.

### BRIEF DESCRIPTION OF THE DRAWINGS

FIG. 1, previously described, is an electric diagram of an example of an optoelectronic circuit comprising light-emitting diodes;

FIG. 2, previously described, is a timing diagram of the power supply voltage and current of the Sight-emitting diodes of the optoelectronic circuit of FIG. 1;

FIG. 3 shows an electric diagram of an embodiment of an optoelectronic circuit comprising light-emitting diodes;

FIG. 4 shows a more detailed electric diagram of an embodiment of the control circuit of the optoelectronic circuit shown in FIG. 3;

FIG. 5 shows a simplified electric diagram illustrating the operation of the control circuit shown in FIG. 4; and

FIG. 6 shows timing diagrams of voltages and of currents during the operation of an embodiment of the optoelectronic circuit of FIG. 3.

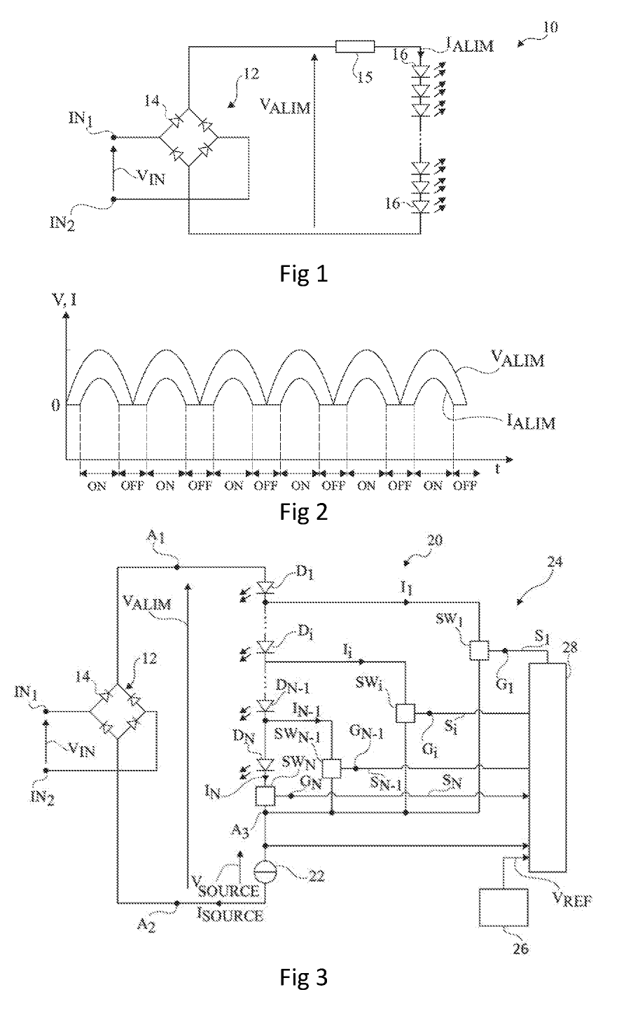

### DETAILED DESCRIPTION OF THE PRESENT EMBODIMENTS

For clarity, the same elements have been designated with the same reference numerals in the various drawings and, further, the various drawings are not to scale. Unless otherwise specified, expressions “approximately”, “substantially”, and “in the order of” mean to within 10%, preferably to within 5%. Further, a signal which alternates between a first constant state, for example, a low state, noted “0”, and a second constant state, for example, a high state, noted “1”, is called “binary signal”. The high and low states of different binary signals of a same electronic circuit may be different. In particular, the binary signals may correspond to voltages or to currents which may not be perfectly constant in the high or low state. Further, in the present description, term “connected” is used to designate a direct electric connection, with no intermediate electronic component, for example, by means of a conductive track, and term “coupled” or term “linked” will be used to designate either a direct electric -connection (then meaning “connected”) or a connection via one or a plurality of intermediate components (resistor, capacitor, etc.). In the following description, the ratio of the active power consumed by the electronic circuit to the product of the effective values of the current and of the voltage powering the electronic circuit Is called “power factor”.

FIG. 3 shows an electric diagram of an embodiment of an optoelectronic circuit 20 comprising a light-emitting diode switching device and illustrating the general operating principle of the optoelectronic circuit. The elements of optoelectronic circuit 20 common with optoelectronic circuit 10 are designated with the same reference numerals. In particular, optoelectronic circuit 20 comprises rectifying circuit 12 receiving power supply voltage V_{IN} between terminals IN₁ and IN₂ and supplying rectified voltage V_{ALIM} between nodes A₁ and A₂. As a variation, circuit 20 may directly receive a rectified voltage, and it is then possible for the rectifying circuit not to be present. The potential at node A₂ may correspond to a low reference potential V_{off}, for example, 0 V. having the voltages of optoelectronic circuit 20 referenced thereto. Unless otherwise mentioned, the potentials are referenced in the following description to low reference potential V_{off}. A high reference potential, called Vₒₙ, may be supplied from power supply voltage V_{ALIM}.

Optoelectronic circuit 20 comprises M series-connected assemblies of elementary light-emitting diodes, called general light-emitting diodes Dᵢ in the following description, where i is an integer in the range from 1 to N and where N is an integer in the range from 2 to 200. Each general light-emitting diode DI to DN comprises at least one elementary light-emitting diode. Preferably, each general light-emitting diode is formed of the series and/or parallel assembly of at least two elementary light-emitting diodes. In the present example, the N general light-emitting diodes Dᵢ are series-connected, the cathode of general light-emitting diode Dᵢ being coupled to the anode of general light-emitting diode Dᵢ₊₁, for i varying from 1 to N−1. The anode of general light-emitting diode D₁ is coupled, preferably connected, to node A₁. General light-emitting diodes Dᵢ, with i varying from 1 to N, may comprise the same number of elementary light-emitting diodes or different numbers of elementary light-emitting diodes.

Optoelectronic circuit 20 comprises a current source 22 having a terminal coupled to node As and having its other terminal coupled to a node A₃. Current source 22 may have any structure and may in particular correspond to an impedance, for example, a resistor. The cathode of general light-emitting diode D_{N} is coupled, preferably connected, to node A₃. Call VS_{OURCE} the voltage across current source 22 and I_{SOURCE} the current flowing through current source 22. Optoelectronic circuit 20 may comprise a circuit, not shown, which supplies a reference voltage to power the current source, possibly obtained from voltage V_{ALIM}. Current source 22 may be continuously controlled by a circuit external to optoelectronic circuit 20.

Circuit 20 comprises a device 24 for switching general light-emitting diodes Dᵢ, with i varying from 1 to N. According to an embodiment, device 24 comprises:

a circuit 26 for supplying a reference voltage V_{REF};

a control circuit 28 capable of receiving voltages VS_{OURCE} and V_{REF}; and

N conduction circuits SW₁ to SW_{N}, each conduction circuit SWᵢ, with i varying from 1 to N, being assembled between node A₃ and the cathode of general light-emitting diode Dᵢ and being controlled by a signal Sᵢ supplied by control circuit 28.

Conduction circuit SWᵢ is a circuit having an equivalent electric resistance varying between a maximum value and a minimum value according to signal Sᵢ. According to an embodiment, when the equivalent electric resistance of conduction circuit SWᵢ is at the maximum value, conduction circuit SWᵢ is substantially equivalent to an off switch. As a variation, current may flow through circuit SWᵢ even when the equivalent electric resistance of conduction circuit SWᵢ is the highest. For i varying from 1 to N, call Iᵢ the current flowing through conduction circuit SWᵢ. In the following description, call Gᵢ a node coupled to the conduction circuit and receiving signal Sᵢ. As a variation, it is possible for conduction circuit SW_{N}, which protects current source 22 from overvoltages, not to be controlled by control unit 28 and to still be on or to be absent, and for the cathode of general light-emitting diode DN to he connected to node A₃. Optoelectronic circuit 20 may further comprise a circuit, not shown, which supplies a reference voltage for the power supply of switching device 24, possibly obtained from voltage V_{ALIM}.

In the present embodiment, the control signal Sᵢ of each conduction circuit SWᵢ is a signal which may continuously vary between a first value and a second value, the equivalent electric resistance of conduction circuit SWᵢ decreasing when signal Sᵢ varies from the first value to the second value. The first and second values of signals Sᵢ, with i varying from 1 to N, may not be the same for all conduction circuits SWᵢ. Preferably, conduction circuit SWᵢ is substantially not conductive when signal Sᵢ is at the first value.

According to an embodiment each conduction circuit SWᵢ is, for example, made of at least one transistor, particularly an enrichment or depletion metal-oxide gate field-effect transistor or MOS transistor. Signal Si then is the potential at the gate of transistor SWᵢ. According to an embodiment, each conduction circuit SWᵢ comprises an N-channel enrichment MOS transistor having its drain connected to the cathode of general light-emitting diode Dᵢ, having its source coupled to node A₃ and having its gate coupled to node Gᵢ. According to another embodiment, conduction circuit SWᵢ comprises two transistors MOS, for example, with an N channel between the cathode of general light-emitting diode Dᵢ and node A₃, the transistor connected to general light-emitting diode Dᵢ being a cascade-assembled high-voltage transistor and the transistor connected to node A₃ being a low-voltage transistor controlled by signal Sᵢ. This advantageously enables to increase the switching speed of conduction circuit SWᵢ. As a variation, each conduction circuit may correspond to a transistor other than a MOS transistor, to a relay, to a microelectromechanical system, and generally to any element having an electric conductivity capable of being monotonously voltage- or current-controlled.

According to an embodiment, circuit 26 for supplying reference voltage V_{REF} is internal to optoelectronic circuit 20. As a variation, reference voltage V_{REF} is supplied to optoelectronic circuit 20 by a circuit external to optoelectronic circuit 20 or is obtained from a modulation signal supplied to optoelectronic circuit 20 by a circuit external to optoelectronic circuit 20. As an example, optoelectronic circuit 20 may comprise a terminal dedicated to the reception of reference voltage V_{REF} or of the modulation signal from which reference voltage V_{REF} is obtained. According to an embodiment, reference voltage V_{REF} or the modulation signal may be supplied by a dimmer, particularly a dimmer capable of being actuated by a user or a luminosity sensor.

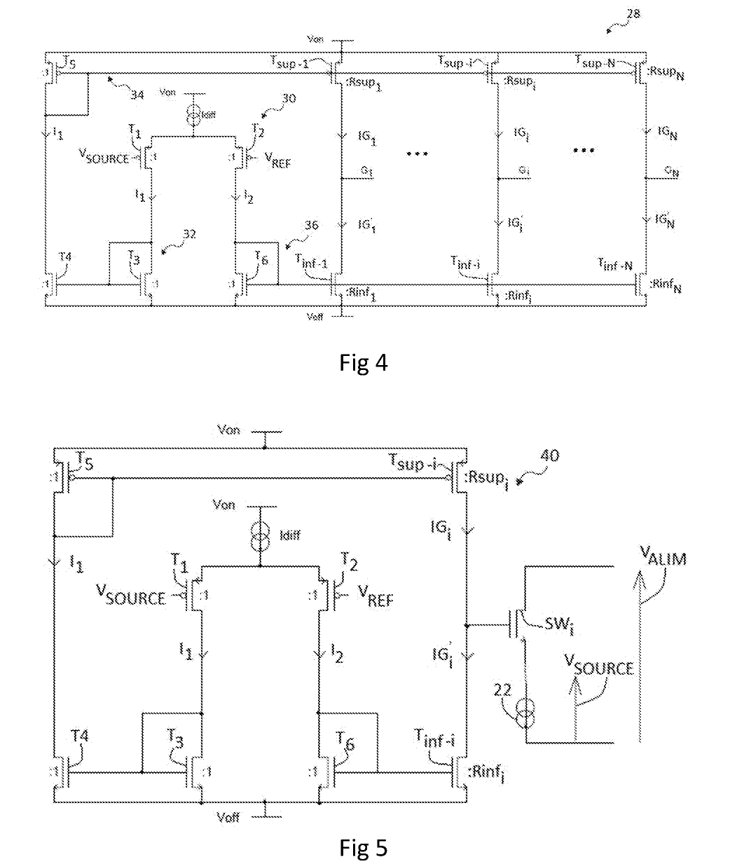

FIG. 4 shows an electric diagram of an embodiment of control circuit 28. Control circuit 28 comprises a transconductance operational amplifier comprising a differential pair 30 and current mirrors 32, 34, and 36. In the present embodiment, signal Sᵢ corresponds to the potential at node Gᵢ.

Differential pair 30 comprises a transistor T₁, for example, a P-channel MOS transistor having its source coupled to a terminal of a current source I_{diff} and having its gate controlled by voltage V_{SOURCE}. The other terminal of current source I_{diff} may be coupled to the source of high reference potential Vₒₙ. Differential pair 30 further comprises a transistor T₂, for example, a P-channel MOS transistor having its source coupled to current source I_{diff} and having its gate controlled by voltage V_{REF}. Call I1 the current at the drain of transistor T₁ and I₂ the current at the drain of transistor T₂. According to an embodiment, transistors T₁ and T₂ have the same characteristics. In particular, the form factor (W/L) of the channel of transistor T₁ is equal to the form factor of the channel of transistor T₂. The form factor of the channel of a transistor designates the ratio of the width to the length of the channel. In the following description, the form factor of the channel of transistor T₃ is taken as the reference form factor.

Current mirror 32 comprises a transistor T₃, for example, an N-channel MOS transistor, having its drain coupled, preferably connected, to the drain of transistor T₁, having its source coupled, preferably connected, to the source of low reference potential V_{off}, for example, node A₂, and having its gate coupled to the drain. Current mirror 32 comprises a transistor T₄, for example, an N-channel MOS transistor, having its source coupled, preferably connected, to the source of low reference potential source V_{off} and having its gate coupled to the gate of transistor T₃. According to an embodiment, transistors T₃ and T₄ have the same characteristics. In particular, the form factor of the channel of transistor T₃ is equal to the form factor of the channel of transistor T₄. The current flowing through transistor T₄ is thus equal to I₁ flowing through T₃.

Current mirror 34 comprises a transistor T₅, for example, a P-channel MOS transistor, having its drain coupled, preferably connected, to the drain of transistor T₄, having its source coupled, preferably connected, to the source of low reference potential Vₒₙ, and having its gate coupled to its drain. Current mirror 34 further comprises for each conduction circuit SWᵢ, with i varying from 1 to N, a transistor Tₛᵤₚ₋ᵢ, for example, a P-channel MOS transistor, having its source coupled, preferably connected, to high reference potential source Vₒₙ, having its gate coupled to the gate of transistor T₅ and having its drain coupled, preferably connected, to node Gᵢ. According to an embodiment, it is possible for transistors Tₛᵤₚ₋ᵢ not to have the same characteristics with respect to one another and with respect to transistor T₅. Call Rₛᵤₚ₋ᵢ the ratio of the form factor of the channel of transistor Tₛᵤₚ₋ᵢ to the form factor of the channel of transistor T₅. In particular, Rₛᵤₚ₋ᵢ may be different from Rₛᵤₚ₋ⱼ, i being different from j. Call IGᵢ the current at the drain of transistor Tₛᵤₚ₋ⱼ.

Current mirror 36 comprises a transistor T₆, for example, an N-channel MOS transistor, having its drain coupled, preferably connected, to the drain of transistor T₂, having its source coupled, preferably connected, to the source of low reference potential V_{off}, and having its gate coupled to its drain. Current mirror 36 further comprises for each conduction circuit SWᵢ, with i varying from 1 to N, a MOS transistor T_{inf-i}, for example, an N-channel MOS transistor, having its source coupled, preferably connected, to low reference potential source V_{off}, having its gate coupled to the gate of transistor T₆, and having its drain coupled, preferably connected, to node Gᵢ. According to an embodiment, it is possible for transistors T_{inf-i} not to have the same characteristics with respect to one another and with respect to transistor T₆. Call R_{inf-i} the ratio of the form factor of the channel of transistor T_{inf-i} to the form factor of the channel of transistor T₆. In particular, R_{inf-i} may be different from R_{inf-j}, being different from j. Call IG′ᵢ the current at the drain of transistor T_{inf-i}.

For i varying from 1 to N, call RatioPNᵢ the ratio of the form factor of the channel of transistor Tₛᵤₚ₋ᵢ to the form factor of the channel of transistor T_{inf-i}, that is, the ratio of Rₛᵤₚ₋ᵢ to R_{inf-i}. According to an embodiment, ratio RatioPNᵢ is greater than ratio RatioPNⱼ for i greater than j. According to an embodiment, for i varying from 1 to N, ratio RatioPNᵢ may vary from 1/N to N. According to an embodiment, the difference between RatioPNᵢ and RatioPNᵢ₊₁ is greater than 1/(N−1)−1/N.

To explain the operation of optoelectronic circuit 20, a control circuit having a simplified structure will first be considered.

FIG. 5 shows an electric diagram of a control circuit 40 comprising all the elements of control circuit 28 shown in FIG. 4, with the difference that a single conduction circuit SWᵢ is present and that the light-emitting diodes are not present.

First consider that ratios Rₛᵤₚ₋ᵢ and R_{inf-1} are equal to 1. In this case, current IGᵢ is equal to current I₁ and current IG′ᵢ is equal to current I₂. At equilibrium, voltage V_{SOURCE} is equal to voltage V_{REF}, currents I₁, I₂, IGᵢ, and IG′ᵢ are equal to I_{diff}/2, and the potential at node Gᵢ is equal to the sum of voltage V_{SOURCE} and of the gate-source voltage of transistor SWᵢ. When voltage V_{SOURCE} becomes greater than voltage V_{REF}, transistor T₁ conducts less than transistor T₂, so that current I₁ becomes lower than current I₂. Current IGᵢ decreases with respect to current IG′ᵢ. Due to the capacitance of node Gᵢ, this causes a decrease in the voltage at the gate of transistor SWᵢ. Transistor SWᵢ thus becomes less conductive and voltage V_{SOURCE} decreases until it is equal to V_{REF} again. When voltage V_{SOURCE} becomes lower than voltage V_{REF}, transistor T₁ conducts more than transistor T₂, so that current I₁ becomes greater than current I₂. Current IGᵢ increases with respect to current IG′ᵢ. Due to the capacitance of node Gᵢ, this causes an increase in the voltage at the gate of transistor SWᵢ. Transistor SWᵢ thus becomes more conductive and voltage V_{SOURCE} rises until it is equal to V_{REF} again. Control circuit 40 thus controls voltage V_{SOURCE} with voltage V_{REF}.

Now consider that the ratio of Rₛᵤₚ₋ᵢ to R_{inf-i} is not equal to 1. The previous line of reasoning remains valid with the difference that, at equilibrium, current I₁ is equal to R_{inf} i*I_{diff}/(R_{inf-1}+Rₛᵤₚ₋ᵢ), current I2 is equal to Rₛᵤₚ₋ᵢ*I_{diff}/(R_{inf-i}+Rₛᵤₚ₋ᵢ), currents IGᵢ and IG′ᵢ are equal to R_{inf-i}*Rₛᵤₚ₋ᵢ*I_{diff}(R_{inf-i}+Rₛᵤₚ₋ᵢ), and there is an offset voltage OFFSETᵢ between voltage V_{SOURCE} and voltage V_{REF}. Offset voltage OFFSETᵢ is proportional to the difference between currents I₁ and I₂ and inversely proportional to the conductance of the differential pair. Offset voltage OFFSETᵢ thus depends on ratio RatioPNᵢ. For the same reasons as those previously described, a variation of voltage V_{SOURCE} with respect to its value at equilibrium causes a variation of the voltage at the gate of transistor SWᵢ, which tends to take voltage V_{SOURCE} back to its value at equilibrium. Control circuit 40 thus controls voltage VS_{OURCE} with voltage V_{REF} decreased by offset voltage OFFSETᵢ.

Now consider again optoelectronic circuit 20 shown in FIG. 4. Control circuit 28 supplies signals Sᵢ to S_{N} at values capable of modifying the conduction of conduction circuits SW₁ to SW_{N} so that voltage V_{SOURCE} is controlled by reference voltage V_{REF} to within an offset voltage OFFSET, which may vary according to the operating point of the optoelectronic circuit. An advantage of switching device 24 is that it has a decreased current consumption. According to an embodiment, in the case where each conduction circuit SWᵢ comprises a MOS transistor having its gate receiving signal Sᵢ, control circuit 28 controls voltage V_{SOURCE} with reference voltage V_{REF} to within an offset voltage OFFSET by controlling the gates of transistors SWᵢ. In other words, differential pair 30 receives as an input the difference between voltage VS_{OURCE} and reference voltage V_{REF}. The reference voltage is identical for all output stages, but the offset voltage is different for each output stage.

In a rising phase of power supply voltage V_{ALIM}, while general light-emitting diodes D₁ to Dᵢ₋₁ are conductive, general light-emitting diodes Dᵢ to D_{N} are non-conductive, signals S₁ to Sᵢ₋₂ are at V_{off}, signals Sᵢ to S_{N} are at Vₒₙ, and signal Sᵢ₋₁ is at a voltage equal to V_{REF}-OFFSETᵢ₋₁+VGSᵢ₋₁ enabling switch SWᵢ₋₁ alone to impose current I_{SOURCE} in the light-emitting diodes, when the voltage across general light-emitting diode Dᵢ becomes greater than the threshold voltage of general light-emitting diode Dᵢ, the latter becomes conductive and a current starts flowing through general light-emitting diode Dᵢ and switch SWᵢ. This results in a temporary decrease of the total equivalent impedance between nodes A₁ and A₃, and thus in a temporary increase of voltage V_{SOURCE}. As previously described, the increase of voltage V_{SOURCE} causes a decrease in current I₁ running through transistor T₁ of differential pair 30. Thereby, the current copied by each transistor Tₛᵤₚ₋ᵢ decreases for i varying from 1 to N. Given that there exists one equivalent capacitor at each node Gᵢ, with 1 varying from 1 to N, capable of corresponding to a different capacitor or to a stray capacitance of another electronic component, and that RatioPNᵢ₋₁ associated with transistors Tₛᵤₚ₋ᵢ₋₁ and T_{inf-i-1} coupled to node Gᵢ₋₁ is smaller than ratios RatioPNᵢ to RatioPN_{N}, the voltage at node Gᵢ₋₁ decreases until potential V_{off} is substantially reached while the voltage at node Gᵢ also decreases down to its point of equilibrium, enabling switch SWᵢ alone to impose voltage V_{SOURCE} at V_{REF}-OFFSETᵢ. Switch SWᵢ₋₁ thus turns off and, simultaneously, switch SWᵢ becomes less and less conductive. The entire current then flows through switch SWᵢ. Control unit 28 then controls voltage V_{SOURCE} with voltage V_{REF} decreased by OFFSETᵢ by means of conduction circuit SWᵢ, offset voltage OFFSETᵢ between voltage V_{SOURCE} and voltage V_{REF} being smaller than offset voltage OFFSETᵢ₋₁. In the case where each conduction circuit SWᵢ comprises a MOS transistor having its gate receiving signal Sᵢ, this means that the voltage at the gate of transistor SWᵢ₋decreases and transistor SWᵢ₋₁ becomes less and less conductive until it reaches its non-conductive state. At equilibrium, the potential at node Gᵢ is equal to the sum of voltage V_{SOURCE} and of the gate-source voltage of transistor SWᵢ.

In a falling phase of power supply voltage V_{ALIM}, while general light-emitting diodes D₁ to Dᵢ are conductive, general light-emitting diodes Dᵢ₊₁ to D_{N} are non-conductive, signals S₁ to Sᵢ₋₁ are at V_{off}, signals Sᵢ₊₁ to S_{N} are at Vₒₙ, and signal Sᵢ is at a voltage equal to V_{REF}−OFFSETᵢ+V_{GSi} enabling switch SWᵢ alone to impose current I_{SOURCE} in the light-emitting diodes, when the voltage across general light-emitting diode Dᵢ decreases and becomes smaller than the threshold voltage of general light-emitting diode Dᵢ, the latter starts becoming non-conductive. This results in a temporary increase of the total equivalent impedance between nodes A₁ and A₃, and thus in a temporary decrease of voltage V_{SOURCE}. As previously described, the decrease of voltage V_{SOURCE} causes an increase in current I₁ running through transistor T₁ of differential pair 30. Thereby, the current copied by each transistor Tₛᵤₚ₋ᵢ increases. Given that there exists an equivalent capacitor at each node Gᵢ, and that ratio RatioPNᵢ of branch i is greater than ratio RatioPN₁ to RatioPNᵢ₋₁, the voltage at node Gᵢ increases until it substantially reaches potential Vₒₙ while the voltage at node Gᵢ₋₁ also increases up to its point of equilibrium enabling switch SWᵢ₋₁ alone to impose voltage V_{SOURCE} at V_{REF}−OFFSETⱼ₋₁. Switch SWᵢ becomes totally conductive and switch SWᵢ₋₁ becomes more and more conductive. The entire current then flows through switch SWᵢ₋₁. Control unit 28 then controls voltage V_{SOURCE} with voltage V_{REF} decreased by OFFSETᵢ₋₁ by means of conduction circuit SWᵢ₋₁, offset voltage OFFSETᵢ₋₁ being higher than offset voltage OFFSETᵢ. In the case where each conduction circuit SWᵢ comprises a MOS transistor having its gate receiving signal Sᵢ, this means that the voltage at the gate of transistor SWᵢ₋₁ increases and that transistor SWᵢ₋₁ becomes more and more conductive and transistor SWᵢ reaches its totally conductive state.

An advantage of the present embodiment is that control circuit 28 comprises no finite state machines and that the order of the control of conduction circuits S Wi is imposed by the differences between ratios RatioPNi.

Advantageously, the embodiment of the previously-described method of controlling switches SWi does not depend on the number of elementary light-emitting diodes which form each general light-emitting diode Di and thus does not depend on the threshold voltage of each general light-emitting diode.

Considering that diodes D₁ to Dᵢ are conductive and that general light-emitting diodes Dᵢ₊₁ to D_{N} are non-conductive, offset voltage OFFSETᵢ decreasing with index i, the voltage at which voltage V_{SOURCE} stabilizes increases with index i. Thereby, current I_{SOURCE} flowing through general light-emitting diodes D₁ to Dᵢ increases with index i. A staged increase of current I_{SOURCE} with voltage V_{ALIM} is thus obtained. Advantageously, the power factor of the optoelectronic circuit is thus increased.

According to another embodiment, circuit 26 for sup-plying reference voltage V_{REF} is capable of modifying the value of reference voltage V_{REF} among a plurality of values according to a control signal supplied by control unit 28. According to an embodiment, considering that diodes D₁ to Dᵢ are conductive and that general light-emitting diodes Dᵢ₊₁ to D_{N} are non-conductive, circuit 26 is controlled to increase the value of reference voltage V_{REF} with index i. The voltage at which voltage V_{SOURCE} stabilizes then increases with index i, independently from the previously-described increase due to the variation of offset voltage OFFSETᵢ. Thereby, current I_{SOURCE} flowing through general light-emitting diodes D₁ to Dᵢ increases with index i. A staged increase of current I_{SOURCE} with voltage V_{ALIM} is thus obtained. Advantageously, the power factor of the optoelectronic circuit is thus increased.

According to another embodiment, current source 22 is capable of supplying a current I_{SOURCE} having an intensity which may take a plurality of values according to a control signal supplied by control unit 28. According to an embodiment, considering that diodes D₁ to Dᵢ are conductive and that general light-emitting diodes Dᵢ₊₁ to D_{N} are non-conductive, current source 22 is controlled to increase current intensity I_{SOURCE} with index i. Advantageously, the power factor of the optoelectronic circuit is thus increased.

Offset voltage OFFSETᵢ tor a given i may foe constant or vary according to temperature, either by increasing when the temperature increases, or by decreasing when the temperature increases. In the case where current source 22 is a resistor and offset voltage OFFSETᵢ decreases when the temperature increases, a temperature increase results in a decrease of current I_{SOURCE} and thus in a decrease of the thermal power supplied by optoelectronic circuit 20. A protection of optoelectronic circuit 20 against a thermal runaway is thus obtained.

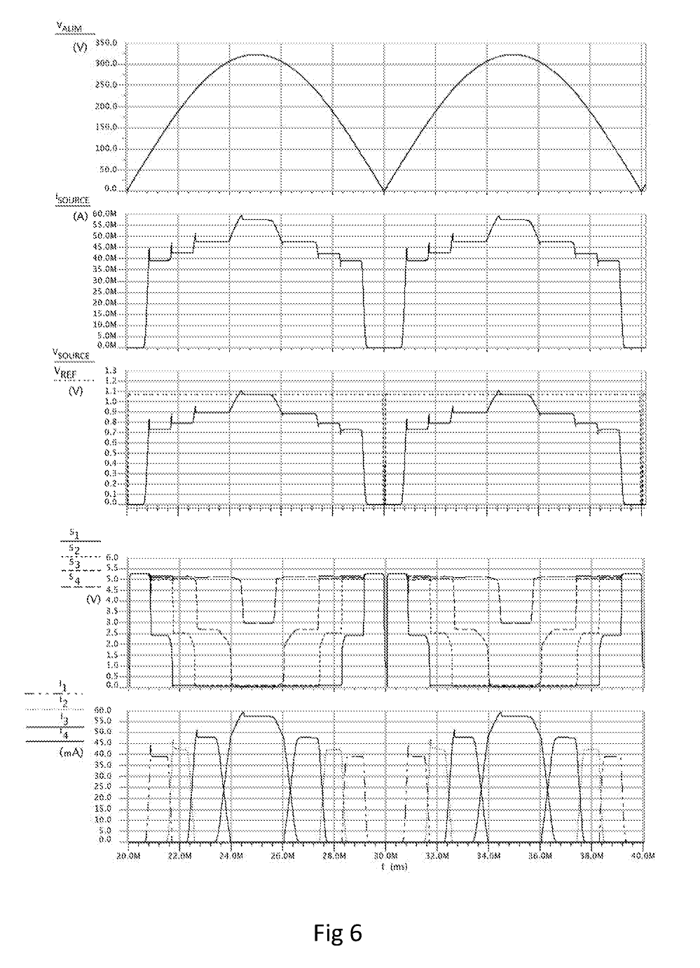

FIG. 6 shows timing diagrams, obtained by simulation, of voltage V_{ALIM}, of current I_{SOURCE}, of voltages V_{SOURCE} and V_{REF}, of voltages S₁, S₂, S₃, and S₄ and of currents I₁, I₂, I₃, and I₄ in the case where voltage V_{ALIM} is obtained from a sinusoidal voltage V_{IN} and in the case where N is equal to 4. To obtain the curves shown in FIG. 6, ratio RatioPN₁ was equal to 1/4, ratio RatioPN₂ was equal to 1/3, ratio RatioPN₃ was equal to 1/2, and RatioPN₄ was equal to 1, and the intensity of the current supplied by current source I_{diff} was equal to 20 μA.

Specific embodiments have been described. Various alterations, modifications, and improvements will readily occur to those skilled in the art. Although detailed embodiments have been described, where the least electrically conductive conduction state of each conduction circuit SWᵢ corresponds to a non-conductive state, it should be clear that these embodiments may also be implemented with a conduction circuit SWᵢ for which the least electrically conductive state however corresponds to a state where current flows through circuit SWᵢ, for example, a current having an intensity smaller than or equal to the theoretical limit, which is the maximum intensity inducing power in conduction circuit SWᵢ capable of being dissipated without causing a malfunction thereof.

Further, in the previously-described embodiments, each transistor Tₛᵤₚ₋ᵢ is capable of copying current I₁ multiplied by copying factor Rₛᵤₚᵢ and each transistor T_{inf-i} is capable of copying current I₂ multiplied by copying factor R_{infi}. As a variation, each transistor T_{inf-i} may be capable of copying a reference current, for example, a constant current, and each transistor Tₛᵤₚ₋ᵢ is capable of copying current I₁ multiplied by copying factor Rₛᵤₚᵢ. As a variation, each transistor Iₛᵤₚ₋ᵢ may be capable of copying a reference current, for example, a constant current, and each transistor T_{inf-i} is capable of copying current I₂ multiplied by copying factor R_{infi}. Different ratios RatioPNᵢ for each conduction circuit SWᵢ and different offset voltages OFFSETᵢ for conduction circuit SWᵢ may thus also be obtained.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. An optoelectronic circuit intended to receive a variable voltage containing an alternation of rising and falling phases, the optoelectronic circuit comprising:
assemblies of series-assembled light-emitting diodes;
a node coupled to each assembly by a conduction circuit having an electric conductance which varies according to a control signal; and
a control circuit coupled to each conduction circuit, comprising a difference amplifier and as many output stages as there are conduction circuits, and capable of supplying each control signal based on the comparison of a first voltage at said node with at least a second voltage identical for all conduction circuits, the control circuit being capable of controlling the first voltage with the second voltage offset by a third voltage, different for each output stage.

2. The optoelectronic circuit of claim 1, wherein the difference amplifier receives as an input a differential voltage corresponding to the difference between the first voltage and the second voltage.

3. The optoelectronic circuit of claim 1, wherein the difference amplifier is capable of supplying a first current and a second current, the control circuit comprising a first current mirror with a plurality of outputs capable of copying, for each conduction circuit, the first current or a third current multiplied by a first copying factor, and a second current mirror with a plurality of outputs capable of copying, for each conduction circuit, the second current or the third current multiplied by a second copying factor, the ratio of the first copying factor to the second copying factor being different for each conduction circuit.

4. The optoelectronic circuit of claim 1, wherein the assemblies of light-emitting diodes are ordered by increasing ranks from a first assembly at a first end of the series to a last assembly at a second end of the series and wherein, for each conduction circuit, the control circuit is capable of controlling the first voltage with the second voltage decreased by a third voltage which decreases with the rank of the assembly having the conduction circuit coupled thereto.

5. The optoelectronic circuit of claim 1, wherein the difference amplifier comprises a differential pair comprising a first transistor receiving the first voltage and a second transistor receiving the second voltage.

6. The optoelectronic circuit of claim 5, wherein the first transistor is a MOS transistor having its gate receiving the first voltage and wherein the second transistor is a MOS transistor having its gate receiving the second voltage.

7. The optoelectronic circuit of claim 3, comprising, for each conduction circuit, a capacitor coupled to the conduction circuit or integrated to the conduction circuit, the first current mirror comprising a capacitor charge circuit and the second current mirror comprising a capacitor discharge circuit.

8. The optoelectronic circuit of claim 1, wherein each conduction circuit comprises a MOS transistor.

9. The optoelectronic circuit of claim 7, wherein each conduction circuity comprises a MPS transistor, and wherein the first current mirror comprises, for each conduction circuit, a first copying block coupled to the gate of the MOS transistor of the conduction circuit and capable of supplying the first current multiplied by the first copying factor and wherein the second current mirror comprises, for each conduction circuit, a second copying block coupled to the gate of the MOS transistor of the conduction circuit and capable of supplying the second current multiplied by the second copying factor.

10. The optoelectronic circuit of claim 1, comprising a current source coupled to said node.

11. The optoelectronic circuit of claim 10, wherein the current source comprises at least one resistor.

12. The optoelectronic circuit of claim 4, comprising a current source coupled to said node, and wherein the current source is capable of supplying a current which increases with the rank of the assembly having the conduction circuit coupled thereto.

13. The optoelectronic circuit of claim 1, wherein the third voltage varies according to temperature.
